(19) United States
(12) Patent Application Publication
(10) Pub. No.: US 2002/0135620 A1
(43) Pub. Date: Sep. 26, 2002

(54) Coordinated knob and display for navigation of hierarchical and range selectors

(75) Inventor: Brian W. Bramlett, Portland, OR (US)

Correspondence Address: MARGER JOHNSON & McCOLLOM, P.C., 1030 S.W. Morrison Street, Portland, OR, 97205, US

(73) Assignee: Intel Corporation, Santa Clara, CA (US)

(21) Appl. No.: 09/816,556

(22) Filed: Mar. 23, 2001

(51) Int. Cl. G06F 3/00

(52) U.S. Cl. 345/810

(57) ABSTRACT

A selection device includes a display and a selector. The selector operates on two axes in an intuitive manner. The display updates itself to reflect the changes in the selection as the user uses the selector.

### RELATED APPLICATION DATA

This invention is related to U.S. patent application Ser. No. ______, titled “Inkjet Stylus,” filed ______, and to U.S. patent application Ser. No. ______, titled “Digital Messaging Pen,” filed ______, both commonly assigned.

### FIELD OF THE INVENTION

This invention pertains to a selection device.

### BACKGROUND OF THE INVENTION

Over the years, many different types of selection devices have been used in many different arts. For example, with Swiss-movement watches, a knob is used to adjust the time set on the watch. For use with computers, mice, light pens, and touch screens have all been used. But all of these devices are limited by the fact that the motions used to select an item from a list are not intuitive to the list itself. For example, with reference to the Swiss-movement watch, the knob used to set the time is rotated in one plane, which is orthogonal to the plane in which the hands of the watch move.

The present invention addresses this and other problems associated with the prior art.

### BRIEF DESCRIPTION OF THE DRAWINGS

FIG. 1 shows a selection device according to an embodiment of the invention.

FIG. 2 shows the procedure used by the selection device of FIG. 1 to navigate a menu.

### DETAILED DESCRIPTION

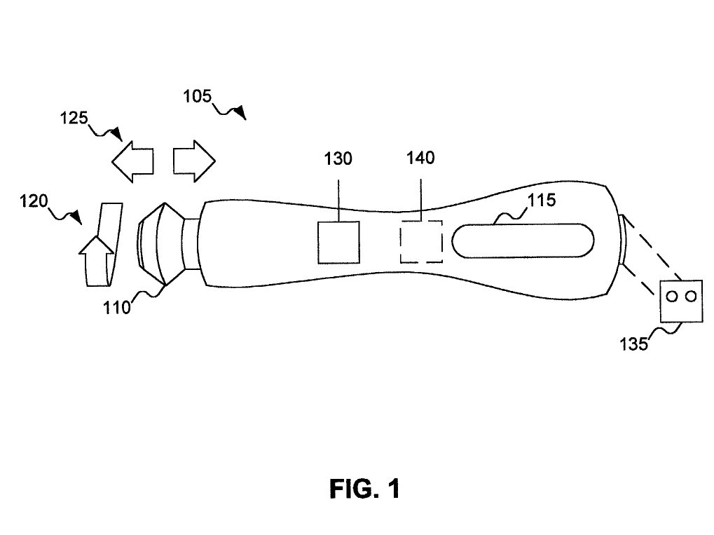

FIG. 1 shows a selection device according to an embodiment of the invention. In FIG. 1, selection device 105 includes knob 110 and display 115. Knob 110 is used to navigate a menu stored within selection device 105. Twisting knob 110 (as shown by arrow 120) allows a user to view the different choices within the menu. Pushing or pulling knob 110 (as shown by arrows 125) allows the user to select or reject a current choice in the menu. A person skilled in the art will recognize that either pushing or pulling knob 110 may be used to select or reject a selection, but it is more intuitive to push knob 110 in the direction of selection device 105 to select a menu choice.

As the user navigates the menu using knob 110 (both by twisting knob 110 as shown by arrow 120 and by pushing or pulling knob 110 as shown by arrow 125), display 115 is updated to reflect the current choice. Thus, as the user twists knob 110 as shown by arrow 120, display 115 scrolls up/down to reflect the change in the selection, “rotating” the selection in display 115 to correspond with the rotation of knob 110 as shown in arrow 120. Then, when the user selects or rejects a selection, display 115 scrolls left/right to reflect the selection or rejection of a choice in the menu.

The menu navigated by the user is stored in memory 130. The menu may be stored initially when selection device 105 is manufactured, or the menu may be installed later, depending on the use of selection device 105. The menu may be fixed and unchanging, or it may be updated over time as needed. If the menu may be updated over time, selection device 105 may include a mechanism for updating the menu. For example, in the embodiment shown in FIG. 1, selection device 105 may include plug 135 to which a second device may be connected. The menu update may then be downloaded from the second device (which may be a computer or any other device with which selection device 105 may interoperate). Alternatively, in a second embodiment, the mechanism for updating the display may include wireless receiver 140, which may be used to receive updates to the menu.

The menu may have only a single level (with one or more selections), or it may have multiple levels. If the menu has multiple levels, then some selections within the menu will cascade to a lower level menu. Accepting these selections will open the lower level menus. Conversely, if the user is at a lower level menu and rejects a selection, the user will be brought to a higher level menu.

Although selection device 105 is described above containing a menu, a person skilled in the art will recognize that other user interface mechanisms may be used. For example, selection device 105 may be used to select a value from a range, to select a color from a list, or to increment or decrement digital value. These other user interface mechanisms may be part of the menu system.

Although selection device 105 is a self-contained device, the selection from the menu may perform an action. In this case, selection device 105 may be included as part of another device. Two examples of ways in which selection device 105 may be incorporated into other devices are described in related U.S. patent application Ser. No. ______, titled “Inkjet Stylus,” filed ______, and U.S. patent application Ser. No. ______, titled “Digital Messaging Pen,” filed ______. Alternatively, selection device 105 may interact with a second device, either via plug 135 or via a wireless transmitter, included with wireless receiver 140.

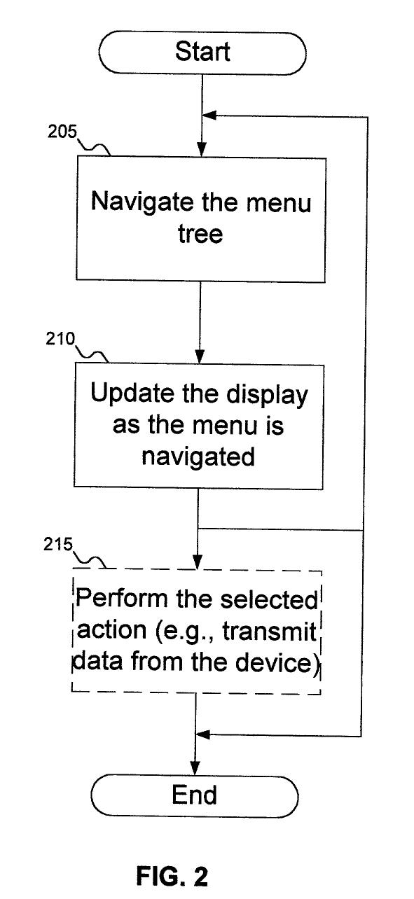

FIG. 2 shows the procedure used by the selection device of FIG. 1 to navigate a menu. At block 205, the user navigates the menu via the knob. This includes changing the selection or selecting or rejecting a choice. At block 210, the display is updated to reflect the changes made by the user when navigating the menu. At this point, if the user is not finished navigating the display, the procedure may return to block 205. Otherwise, if there is an action associated with the selection, then at block 215 the selection device performs the associated action. This may include transmitting information from the selection device to a second device. A person skilled in the art will recognize that performing an action is not necessary, and block 215 may be skipped.

Having illustrated and described the principles of my invention in an embodiment thereof, it should be readily apparent to those skilled in the art that the invention can be modified in arrangement and detail without departing from such principles. I claim all modifications coming within the spirit and scope of the accompanying claims.

I claim:

1. A selection device comprising:
a display designed to present a selection; and
a selector operable in two independent axes, a first axis for changing the selection and a second axis for acceptance or rejection of the selection.

2. A selection device according to claim 1, wherein the first axis of the selector is a rotation axis.

3. A selection device according to claim 2, wherein the display changes in relation to the rotation of the selector around the rotation axis.

4. A selection device according to claim 1, wherein the selection opens a sub-menu for further selection with the selection device.

5. A selection device according to claim 1, wherein the selection is designed to scroll across the display in the direction the selector is moved.

6. A selection device according to claim 1, the selection device further comprising interconnection means for interconnecting the selection device with a second device to exchange data.

7. A selection device according to claim 6, wherein the interconnection means includes a plug designed to accept a cable between the selection device and the second device.

8. A selection device according to claim 6, wherein the interconnection means includes a wireless transmitter.

9. A selection device according to claim 6, wherein the interconnection means includes a wireless receiver.

10. A method for using a selection device, the method comprising:
navigating a menu using the selection device, the menu including at least one selection, the selection device operable in two independent axes, a first axis for changing a selection and a second axis for acceptance or rejection of the selection;
displaying the selection in a display; and
performing an operation responsive to the selection.

11. A method according to claim 10, wherein navigating a menu includes changing the selection as the selection device is operated along the first axis.

12. A method according to claim 10, wherein navigating a menu includes accepting or rejecting the selection as the selection device is operated along the second axis.

13. A method according to claim 10, wherein navigating a menu includes updating the display as the selection changes.

14. A method according to claim 13, wherein updating the display includes scrolling the display in an up/down direction as the selection device is operated along the first axis.

15. A method according to claim 13, wherein an updating the display includes scrolling the display in a left/right direction as the selection device is operated along the second axis.

16. A method according to claim 10, the method further comprising communicating with a second device.

17. A method according to claim 16, wherein communicating with a second device includes communicating with a second device via a cable.

18. A method according to claim 16, wherein communicating with a second device includes wirelessly communicating with a second device.

19. A method according to claim 10, wherein:
the menu includes at least two levels; and performing an operation includes opening a second level of the menu.

20. An article comprising:
a storage medium, said storage medium having stored thereon instructions, that, when executed by a selection device, result in:
navigating a menu using the selection device, the menu including at least one selection, the selection device operable in two independent axes, a first axis for changing a selection and a second axis for acceptance or rejection of the selection;
displaying the selection in a display; and
performing an operation responsive to the selection.

21. An article according to claim 20, wherein navigating a menu includes changing the selection as the selection device is operated along the first axis.

22. An article according to claim 20, wherein navigating a menu includes accepting or rejecting the selection as the selection device is operated along the second axis.

23. An article according to claim 20, wherein navigating a menu includes updating the display as the selection changes.

24. An article according to claim 23, wherein updating the display includes scrolling the display in an up/down direction as the selection device is operated along the first axis.

25. An article according to claim 23, wherein an updating the display includes scrolling the display in a left/right direction as the selection device is operated along the second axis.

26. An article according to claim 20, the method further comprising communicating with a second device.

27. An article according to claim 26, wherein communicating with a second device includes communicating with a second device via a cable.

28. An article according to claim 26, wherein communicating with a second device includes wirelessly communicating with a second device.

29. An article according to claim 20, wherein:
the menu includes at least two levels; and
performing an operation includes opening a second level of the menu.
